(19) United States
(12) Patent Application Publication
(10) Pub. No.: US 2016/0003660 A1
(43) Pub. Date: Jan. 7, 2016

(54) FUEL MEASUREMENT SYSTEM

(71) Applicant: RAMON MARTINEZ, JR., SAN ANTONIO, TX (US)

(72) Inventor: RAMON MARTINEZ, JR., SAN ANTONIO, TX (US)

(21) Appl. No.: 14/324,982

(22) Filed: Jul. 7, 2014

(51) Int. Cl. G01F 23/00; G01F 23/24; G01F 23/20

(52) U.S. Cl. CPC G01F 23/00; G01F 23/20; G01F 23/24; G01F 23/246

(57) ABSTRACT

A fuel measurement system is configured to determine an amount of a fuel in a tank. The fuel measurement system contains at least one transmitter and receiver configured to dispatch an emission wave through the tank which are reflected off of the tank and returned as returned waves. Time for the emission wave to return to the at least one transmitter and receiver is measured. An integrated circuit is communicatively coupled to the at least one transmitter and receiver and a thermocouple. The time is communicated from the at least one transmitter and receiver to the integrated circuit. The time is used to calculate the amount of the fuel in the tank. A display is configured to show the amount of the fuel remaining the in the tank.

### BACKGROUND

The embodiments herein relate generally to systems that can measure a quantity of gaseous material in a tank.

Prior to embodiments of the disclosed invention, propane tanks, such as those used for, e.g., outdoor grilling and heaters, did not display the amount of fuel remaining in the tank. An individual who is using one of these tanks may be taken by surprise when the tank becomes empty and may not have a replacement tank immediately available. By picking up the tank and gauging its weight, a user may be able to estimate how much fuel is left in the tank, but this practice is error-prone. For example, the user must be familiar with both the empty weight and full weight of the tank without having access to such tanks or comparable weights for comparison purposes. Previously, gauges attached to the fuel line, making installation time consuming and error prone. There was no gauge for a propane tank that is accurate and easy to install and remove. Embodiments of the disclosed invention solve these problems.

### SUMMARY

A fuel measurement system is configured to determine an amount of a fuel in a tank. The fuel measurement system contains at least one transmitter and receiver configured to dispatch an emission wave through the tank which are reflected off of the tank and returned as returned waves. Time for the emission wave to return to the at least one transmitter and receiver is measured. An integrated circuit is communicatively coupled to the at least one transmitter and receiver and a thermocouple. The time is communicated from the at least one transmitter and receiver to the integrated circuit. The time is used to calculate the amount of the fuel in the tank. A display is configured to show the amount of the fuel remaining the in the tank.

In some embodiments, a body can be mechanically coupled to the at least one transmitter and receiver. A magnet can be mechanically coupled to the body. The magnet can be configured to detachably coupled the body to the tank.

In some embodiments the display can be a dial face or a digital display mechanically coupled to the body. In some embodiments, the display is a computer peripheral device.

A fuel measurement system can configured to determine an amount of a fuel in a tank. The fuel measurement system can include a scale and a thermocouple that can be configured to weigh the tank. An integrated circuit can be communicatively coupled to the scale and the thermocouple. A weight of the tank and the fuel can be used to calculate the amount of the fuel in the tank. A display can be configured to show the amount of the fuel remaining in the tank.

In some embodiments, a body can be mechanically coupled to the display. A magnet can be mechanically coupled to the body. The magnet is configured to detachably coupled the body to the tank.

In some embodiments the display can be a dial face or a digital display mechanically coupled to the body. In some embodiments, the display is a computer peripheral device.

A fuel measurement system can be configured to determine an amount of a fuel in a tank. The fuel measurement system can include a magnetic thermotropic liquid crystal strip magnetically coupled to the tank. The magnetic thermotropic liquid crystal strip can further comprise liquid crystals in a state that has properties between those of conventional liquid and those of solid crystal. The liquid crystals can thermotropic as ordering of the liquid crystals can be determined or changed by temperature of the amount of the fuel in the tank. The magnetic thermotropic liquid crystal strip can be configured to change color to reflect a level of the fuel in the tank.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention shown in use.

FIG. 2 is a perspective view of an embodiment of the invention.

FIG. 3 is a rear perspective view of an embodiment of the invention.

FIG. 4 is an exploded view of an embodiment of the invention.

FIG. 5 is a section view of an embodiment of the invention taken along line 5-5 in FIG. 1.

FIG. 6 is a perspective view of an embodiment of the invention.

FIG. 7 is a front view of an embodiment of the invention.

### DETAILED DESCRIPTION OF CERTAIN EMBODIMENTS

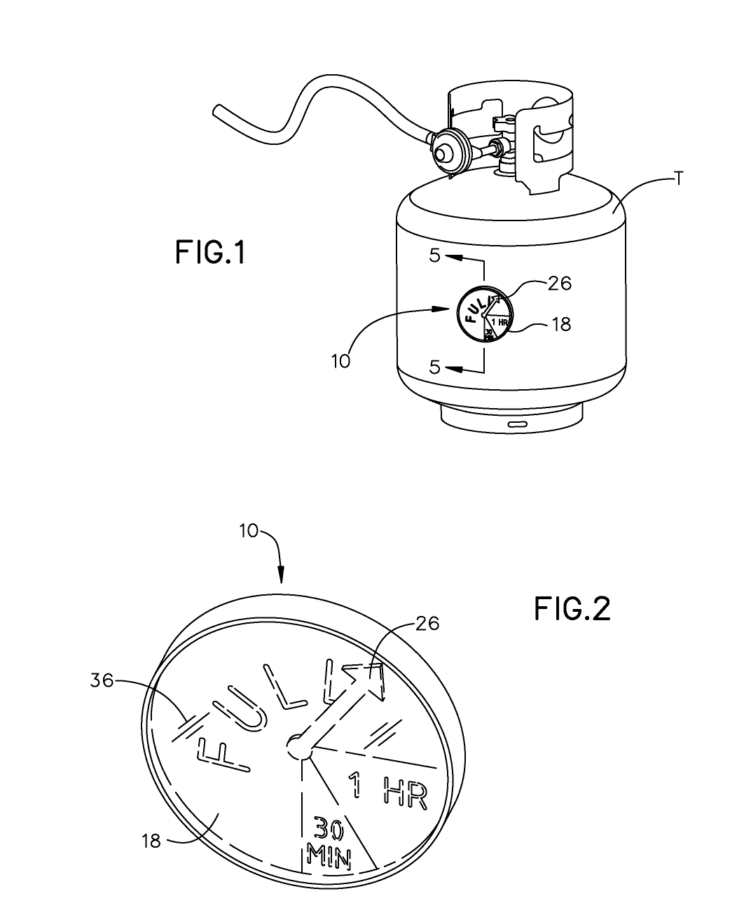

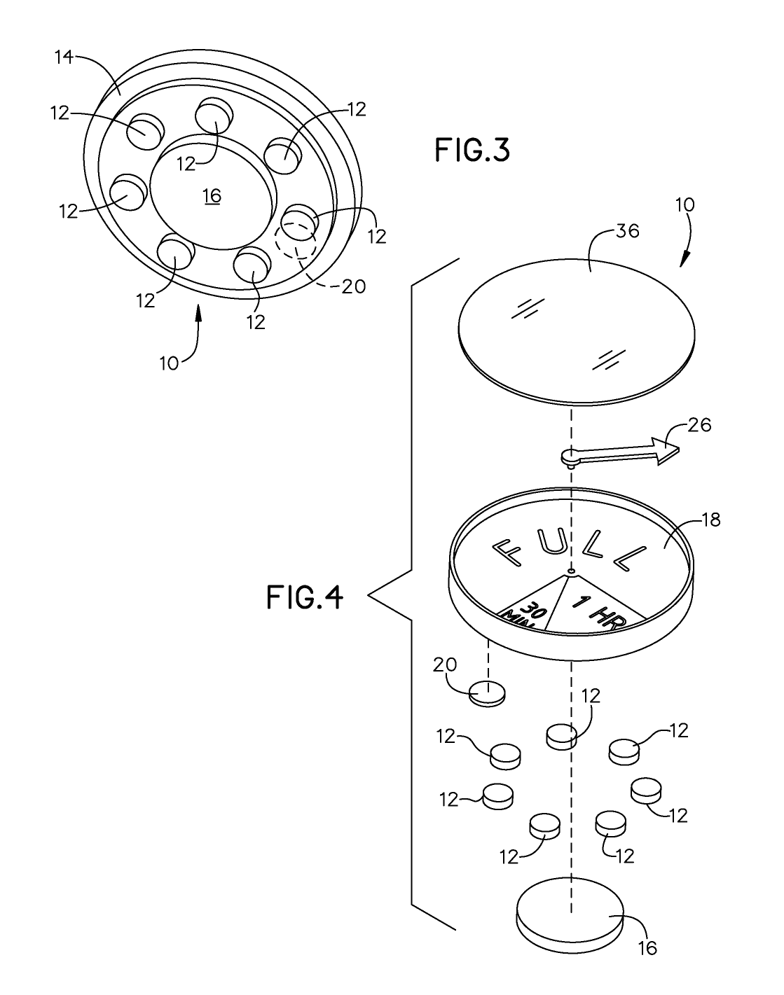

By way of example, and referring to FIG. 1, FIG. 2, FIG. 3 and FIG. 4, one embodiment of fuel measurement system 10 comprises at least one transmitter and receiver 12 mechanically coupled to body 14. Body 14 is further mechanically coupled to magnet 16. Body 14 is further attached to integrated circuit 20.

In some embodiments, body 14 is further attached to dial 18. Dial face 18 is mechanically coupled to dial 26. Dial face 18 is covered with dial cover 36.

Turning to FIG. 5, fuel measurement system 10 us magnetically coupled to tank T with magnet 16. At least one transmitter and receiver 12 is communicatively coupled to integrated circuit 20. Integrated circuit 20 is powered with a direct current power source, such as a battery, a solar cell or both, among other options. Integrated circuit 20 is electrically coupled to dial 18 and a thermocouple.

In one mode of operation, integrated circuit 20 instructs at least one transmitter and receiver 12 to emit emission wave 30. Emission wave 30 travels through tank T and reflects off of a distal point of tank T as deflection wave 32. Deflection wave 32 then returns to at least one transmitter and receiver 12 as return wave 34. These waves can be any kind of effective wave for measurement impedance. The academic literature focuses on waves in the sound range, but there is no requirement to use those. The acoustic impedance of methane is a function of density and temperature.

The density of liquid propane at 25° C. (77° F.) is 493 kg/m³, which is equivalent to 4.11 pounds per U.S. liquid. At that point acoustic impedance is 31.8 g/cm²-sec. Propane expands at 1.5% per 10° F. Thus, liquid propane has a density of approximately 4.2 pounds per gallon (504 kg/m³) at 60° F. (15.6° C.). In that regard, temperature can be readily ascertained by the thermocouple leaving only density to be determined by the integrated circuit. For instance, a typical 20-gallon tank will be filled with 3.6 gallons or 15 pounds of propane. This would indicate “full” on dial 26. To the extent that experimentation would be necessary to populate date into the processor, analytical techniques are known, available, and summarized in Liu, Y. Acoustic Properties of Reservoir Fluids (Stanford 1998) which is available here: https ://pangea.stanford. edu/departments/geophysics/dropbox/SRB/public/docs/theses/SRB_{—}067_JUN98_Liu.pdf and incorporated by reference.

The density of whatever propane is in tank T can be measured by measurement the time it takes emission wave 30 to return to at least one transmitter and receiver 12. In some embodiments of the invention, more than one transmitter and receiver 12 can be electrically coupled to integrated circuit 20. The times computed by the waves that are sent and received from these transmitter and receivers 12 can be averaged to determine a more accurate estimate of the amount of propane in tank T.

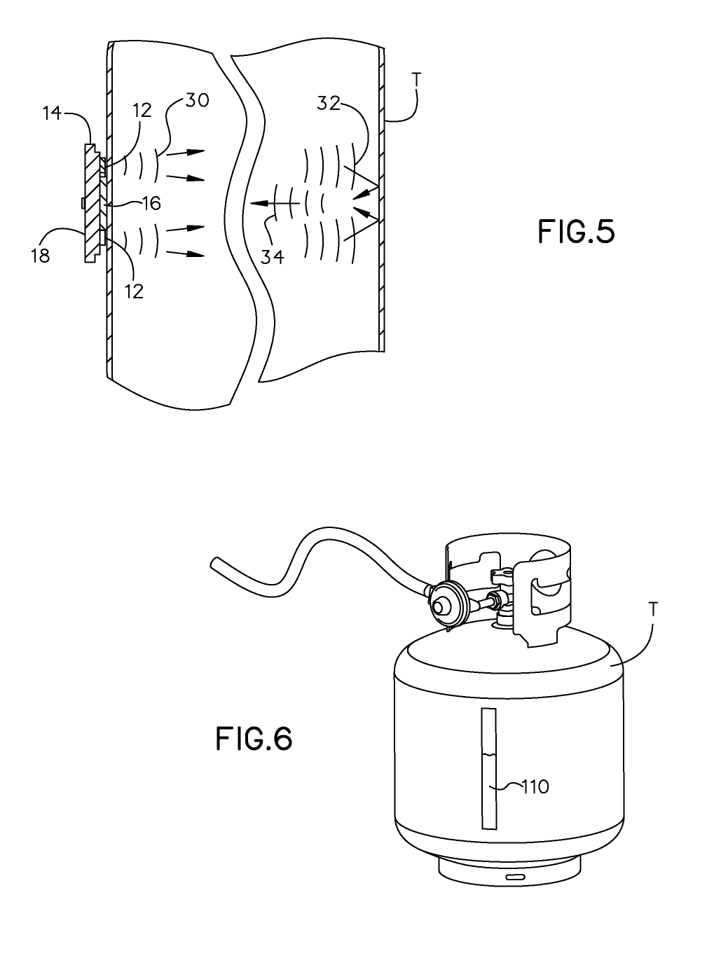

Turning to FIG. 6, in some embodiments, magnetic thermotropic liquid crystal strip 110 can be magnetically coupled to tank T. Liquid crystals are matter in a state that has properties between those of conventional liquid and those of solid crystal. A liquid crystal is thermotropic if the order of its components is determined or changed by temperature. A thermotropic liquid crystal strip is configured to change color to reflect a level of liquid propane in tank T. The thermotropic liquid crystal strip can have a magnetic backing making it a magnetic thermotropic liquid crystal strip.

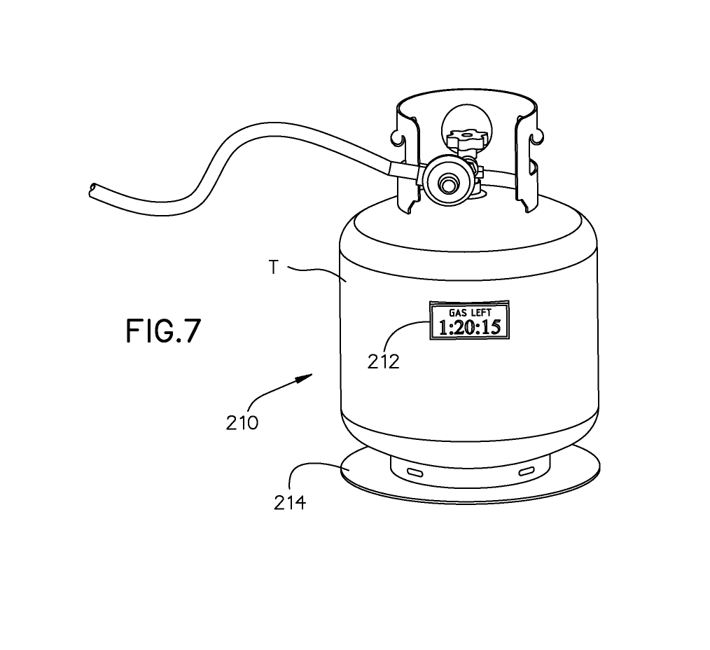

Turning to FIG. 7, in some embodiments, or perhaps to calibrate integrated circuit 20, weighing system 210 can be utilized. A 20-pound propane tank weighs 20 pounds when empty and about 35 pounds when filled with 15 pounds of propane as noted above. Taking a time derivative of the amount of gas leaving the tank can be used to determine the amount of propane left in the tank on digital screen 212. Digital screen 212 is mechanically coupled to body 14 and communicatively coupled to scale 214. Sale 214 can determine the weight of tank T and its enclosed propane which can be used independently or alongside at least one transmitter and receiver 12 to determine the amount of propane in tank T. In some embodiments, the display can be analog as in FIGS. 1-4 or digital as in FIG. 7. In either event, the display is configured to display the amount of fuel in the tank. In some embodiments the digital screen can be on a computer peripheral device such as a smartphone, tablet or computer.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A fuel measurement system, configured to determine an amount of a fuel in a tank, the fuel measurement system comprising:
at least one transmitter and receiver configured to dispatch an emission wave through the tank which are reflected off of the tank and returned as returned waves;
wherein time for the emission wave to return to the at least one transmitter and receiver is measured;
an integrated circuit; communicatively coupled to the at least one transmitter and receiver and a thermocouple; wherein the time is communicated from the at least one transmitter and receiver to the integrated circuit; wherein the time is used to calculate the amount of the fuel in the tank; and
a display configured to show the amount of the fuel remaining the in the tank.

2. The fuel measurement system of claim 1, further comprising:
a body mechanically coupled to the at least one transmitter and receiver; and
a magnet mechanically coupled to the body; wherein the magnet is configured to detachably coupled the body to the tank.

3. The fuel measurement system of claim 2, wherein the display is a dial face mechanically coupled to the body.

4. The fuel measurement system of claim 2, wherein the display is a digital screen mechanically coupled to the body.

5. The fuel measurement system of claim 2, wherein the display is a computer peripheral device.

6. A fuel measurement system, configured to determine an amount of a fuel in a tank, the fuel measurement system comprising:
a scale and a thermocouple, configured to weigh the tank;
an integrated circuit; communicatively coupled to the scale and the thermocouple;
wherein a weight of the tank and the fuel is used to calculate the amount of the fuel in the tank; and
a display configured to show the amount of the fuel remaining in the tank.

7. The fuel measurement system of claim 6, further comprising:
a body mechanically coupled to the display; and
a magnet mechanically coupled to the body; wherein the magnet is configured to detachably coupled the body to the tank.

8. The fuel measurement system of claim 7, wherein the display is a dial face mechanically coupled to the body.

9. The fuel measurement system of claim 7, wherein the display is a digital screen mechanically coupled to the body.

10. The fuel measurement system of claim 7, wherein the display is a computer peripheral device.

11. A fuel measurement system, configured to determine an amount of a fuel in a tank, the fuel measurement system comprising:
a magnetic thermotropic liquid crystal strip magnetically coupled to the tank;
wherein the magnetic thermotropic liquid crystal strip further comprises liquid crystals in a state that has properties between those of conventional liquid and those of solid crystal;
wherein the liquid crystals are thermotropic as ordering of the liquid crystals is determined or changed by temperature of the amount of the fuel in the tank; and
wherein the magnetic thermotropic liquid crystal strip is configured to change color to reflect a level of the fuel in the tank.
